(19) United States
(12) Patent Application Publication
(10) Pub. No.: US 2013/0187492 A1
(43) Pub. Date: Jul. 25, 2013

(54) WHEEL-HUB MOTOR COOLING

(71) Applicant: Tim Woolmer, Oxfordshire (GB)

(72) Inventor: Tim Woolmer, Oxfordshire (GB)

(73) Assignee: Oxford Yasa Motors Limited, Abingdon Oxfordshire (GB)

(21) Appl. No.: 13/877,735

(22) PCT Filed: Oct. 10, 2011
(86) PCT No.: PCT/GB11/51939

§ 371 Date: Apr. 4, 2013

(51) Int. Cl. H02K 9/20

(52) U.S. Cl. CPC H02K 9/20
USPC 310/54

(57) ABSTRACT

A wheel-hub motor (100) comprises a rotor (14) having permanent magnets, although other field generation means are available, and a stator (12). The stator has coils (22) wound on stator bars (16) for interaction with the magnetic field of the rotor across an air gap (26a,b) defined between them. The stator (12) forms a housing of a chamber (70) containing refrigerant (82). The stator housing has heat dissipating fins (96) accessible by the open environment whereby air movement relative to the housing caused at least by rotation of the rotor absorbs heat from the fins. The motor may be an axial flux machine, the coils being wound on bars that are disposed circumferentially spaced around a rotation axis (80) of the rotor. The wheel of the vehicle is mounted directly on the rotor housing.

This invention relates to a wheel-hub motor comprising a stator and a rotor journalled for rotation in the stator. The stator is provided with coils and the rotor is provided with means to generate a rotor magnetic field to cooperate with the coils across an air gap between the rotor and stator. The motor may be an axial flux machine. In particular it relates to a yokeless and segmented armature motor (hereinafter termed a “Y machine”) for a wheel-hub, particularly to a permanent magnet motor. Wheel-hub motors are, of course, known for driving individual wheels of a vehicle. Such vehicles have numerous advantages the details of which do not require discussion herein.

### BACKGROUND

Woolmer and McCulloch [1] describe the topology of a Y machine, discussing its advantages of reduced iron in the stator enabling an improvement in torque density. It comprises a series of coils wound around bars spaced circumferentially around the stator, ideally axially disposed, (ie parallel the rotation axis of the rotor). The rotor has two stages comprising discs provided with permanent magnets that face either end of each coil of the stator. The magnetic path at any stage of operation is: through a first coil into a first magnet on a first stage of the rotor; across a back iron of the rotor to an adjacent second magnet on the first stage; through a second coil of the stator adjacent the first coil; into a first magnet on the second stage of the rotor aligned with the second magnet on the first stage; across the back iron of the second stage to a second magnet on the second stage and aligned with the first magnet on the first stage; and completing the circuit through the first coil.

One difficulty with electric machines generally is to provide adequate cooling. This is a particular problem with a Y machine having a high torque density that significant heat is generated in the coils at high torques and is often a limiting factor in the torques that can be employed, at least for extended periods of time. Also, the coils are isolated from one another and therefore cooling only one region of the motor is insufficient as there is low conduction of heat between coils.

WO-A-2006/066740 discloses a Y machine comprising a housing having a cylindrical sleeve mounting stator coils internally, the sleeve being hollow whereby cooling medium is circulated. However, the coils are embedded in a thermally conducting material to carry heat to stator housing. A rotor is rotatably journalled in the housing. The stator bars appear to be laminated, as they are in GB-A-2379093 that also discloses a Y machine, as does WO-A-03/094327. No cooling arrangements are mentioned.

U.S. Pat. No. 6,720,688 discloses a Y machine in which the rotor acts as a vane pump to circulate fluid within a chamber defined by a stator housing through which a rotor shaft, supported on bearings in the housing and carrying the rotor, extends. The fluid cools stator coils.

Of course, cooling problems are not limited to Y motors.

The idea of evaporative cooling has been employed in, for example, SU-955379, where a hollow rotor shaft appears to extend into an external rotating housing so that refrigerant evaporating in the shaft cools the rotor and vapour condenses in the external housing releasing its heat before returning as a liquid. U.S. Pat. No. 5,394,040 discloses a similar arrangement. These devices are passive, where the cooling circuit is self-driven, but more active arrangements are disclosed. SE-A-7411152 likewise appears to disclose evaporative cooling of a motor. U.S. Pat. No. 3,217,193 sprays liquid refrigerant on the hot parts of a motor or generator. US-A-2007/0199339 discloses a complete refrigerant circuit with valves ensuring correct directional flow between passages through the stator and an external heat exchanger. This development is of particular interest to the present invention which finds a primary application in wheel motors for vehicles.

Our copending international application number PCT/GB2010/050613 (WO-A-2010/119281) describes and claims an electric machine comprising a rotor having a rotor field and a stator having coils for magnetic interaction with the rotor field across an air gap defined between the rotor and stator, wherein the stator is a fixed component with respect to a mounting for the machine and the rotor rotates around the stator externally thereof forming a rotating housing defining a sealed chamber between the rotor and stator incorporating cooling medium to cool the coils, and wherein the cooling medium has a boiling point less than a design temperature of operation of the stator and more than design temperature of operation of the rotor housing, and wherein the rotor housing has a heat dissipating external surface accessible by a coolant. It is an object of the present invention to provide an arrangement for a wheel-hub motor having a more traditional layout of stator and rotor where the stator forms the external housing of the motor and in which the rotor rotates. It is still an object to have passive, evaporative cooling and to minimize the additional elements and equipment required for cooling, whereby the cost in terms of power lost through the cooling arrangements can be minimized.

### BRIEF SUMMARY OF THE DISCLOSURE

In accordance with the present invention there is provided a wheel-hub motor comprising:
a rotor having a rotor field, and
a stator having coils for magnetic interaction with the rotor field across an air gap defined between the rotor and stator;
wherein the stator is a fixed component with respect to a mounting for the motor in a vehicle and the rotor rotates inside the stator that forms a stationary housing defining a sealed chamber between the rotor and stator incorporating cooling medium to cool the coils;
wherein the cooling medium has a boiling point less than a design temperature of operation of the stator coils and more than the design temperature of operation of the stator housing, whereby liquid cooling medium contacting the coils evaporates and gaseous cooling medium contacting the stator housing condenses transferring heat of vapourisation between the stator coils and housing;
wherein the stator housing has a heat dissipating external surface for transfer of heat conducted from an internal surface of the stator housing contacted by the gaseous cooling medium; and
wherein the rotor is adapted to mount a hub/wheel such that rotation of the hub/wheel around the stator housing induces a flow of air over the heat dissipating external surface of the housing to accelerate cooling of the housing.

The chamber in use comprises a volume that is preferably filled to less than about 25% by volume with said cooling medium when liquid. The volume ratio of liquid to vapour changes as temperature rises and pressure increases. The fill volume of less than 25% refers to ambient conditions. Preferably the remaining volume is filled only with the cooling medium in vapour form, but it may also contain air or another medium, such as inert gas. The pressure in the chamber will depend on the mix ratio between the cooling medium and air/gas. It s preferable that the pressure is at ambient when the machine is not operating, so that seals are not permanently operating with a pressure differential across them. However, this requires the cavity to be part filled with air or other inert gas and this will impact the cooling capability of the system. Alternatively, the cavity can contain the working fluid only which will mean that, at ambient, the internal pressure will be less than atmospheric Pressure accommodating means they may be provided to reduce the pressure differential at ambient.

Preferably, the motor is an axial flux machine, the coils being wound on bars that are disposed circumferentially spaced around the housing. Preferably, the bars are parallel to the rotational axis. The rotor may comprise two stages each having permanent magnets interacting with each end of the bars.

Preferably, the stator is mounted on a wishbone of the vehicle when mounted therein. The rotor may be rotationally journalled directly on the stator coils, or in the stator housing.

Preferably, the rotor stages each comprise an annular dish, whose inner rims are connected together by a sleeve and which dishes mount said permanent magnets.

Preferably, said stator housing has fins to shed heat externally. The fins may be radially directed or axially directed.

Preferably, diffusive material is disposed around and between said coils whereby liquid cooling medium is captured and transported to the coils by capillary action and vapour from the liquid cooling medium evaporating from the coils escapes. The diffuse material acts as a wick, similar to its application in a heat pipe.

Preferably, paddles are disposed on the rotor to help distribute the liquid cooling medium around the stator (particularly the coils) and motor electronics.

Thus, in one aspect, the invention provides a vehicle having a wishbone suspended from vehicle and on which a motor as defined above is mounted. Preferably, a wheel of the vehicle is mounted on said rotor. A hub may be disposed between the wheel and the rotor, said hub incorporating agitation means to wash ambient air around the stator housing.

Preferably, regenerative braking is employed to retard the vehicle. In any event, preferably, a brake disc is mounted on said rotor, via said hub, when present. The wheel preferably has apertures to allow access to air passing the vehicle to flow through the wheel to cool the stator housing. Preferably, said fins are shaped to draw air through said apertures. Said shape may be the fins having a helical form on said housing.

The invention provides a wheel-hub motor wherein the effects of evaporative cooling of a liquid refrigerant within the motor and cooling airflow around the outside of the motor (caused by rotation of the motor) combine to produce a motor that requires no external connections insofar as cooling is concerned. Such connections are always problematic, especially with a steered wheel whereby the connections must be flexible, adding to the complications of electrical connections for operation of the motor and hydraulic connections for operation of the disc brake.

### BRIEF DESCRIPTION OF THE DRAWINGS

Embodiments of the invention are further described hereinafter with reference to the accompanying drawings, in which:

FIG. 1 is a schematic side view of a yokeless and segmented armature machine to which the present invention primarily (but not exclusively) relates;

FIG. 2 is a perspective view of the arrangements of FIG. 1;

FIG. 3 is a side section of a motor in accordance with the present invention; and

FIG. 4a and b are respectively a perspective view of the stator of the motor of FIG. 3 and a side view of a detail of FIG. 4a.

### DETAILED DESCRIPTION

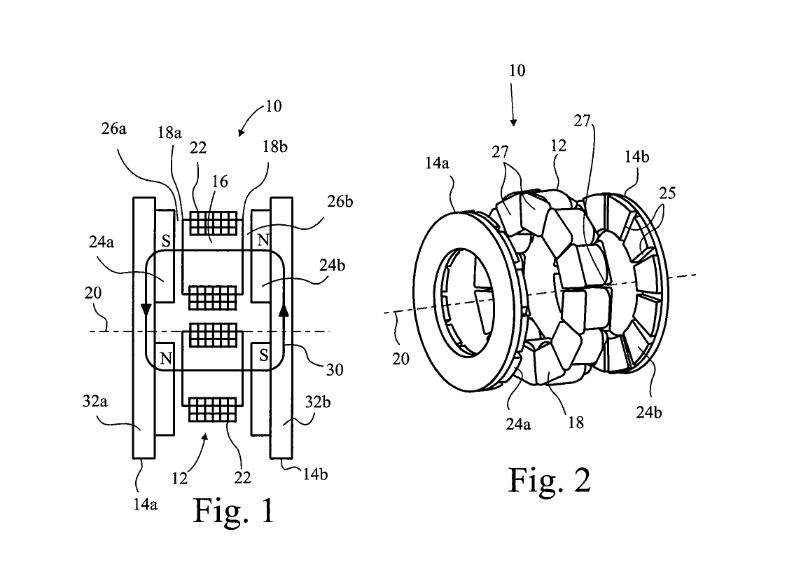

A yokeless and segmented armature machine 10 is illustrated schematically in FIG. 1. The machine 10 comprises a stator 12 and two rotors 14a,b. The stator 12 is a collection of separate stator bars 16 spaced circumferentially about a rotation axis 20 of the rotors 14a,b. Each bar 16 has its own axis 16a which is disposed parallel to the rotation axis 20. However, that is not absolutely essential. In an axial flux machine, the axis 16a is indeed parallel the rotation axis 20. However, it can be disposed at any angle thereto, even radially with respect to the rotation axis 20. The following discussion is in respect of an axial flux machine, but this should not be understood to be limiting in any sense and, where the context permits, the invention equally applies to other inclinations of the stator bars 16.

Each end of each stator bar is provided with a shoe 18a,b which serves a physical purpose of confining a coil stack 22, which stack 22 is preferably of square section insulated wire (or possibly rectangular section) so that a high fill factor can be achieved. The coils 22 are connected to an electrical circuit (not shown) that (in the case of a motor) energizes the coils so that the poles of the resultant magnetic fields generated by the current flowing in the coils is opposite in adjacent stator coils 22.

The two rotors 14a,b carry permanent magnets 24a,b that face one another with the stator coil 22 between. Indeed, in the axial flux machine, the rotors and their magnets are radially disposed, but when the stator bars are inclined, then they are likewise. Two air gaps 26a,b are disposed between respective shoe and magnet pairs 18a/24a, 18b/24b. There are an even number of coils and magnets spaced around the axis of rotation 20 and, preferably, there are a different number of coils and magnets so that each coil does not come into registration with a corresponding magnet pair all at the same time and at the same rotational position of the rotor with respect to the stator. This serves to reduce cogging.

In a motor (with which the present invention is concerned) the above-mentioned electric circuit is arranged to energize the coils 22 so that their polarity alternates serving to cause coils at different times to align with different magnet pairs, resulting in torque being applied between the rotor and the stator. The rotors 14a,b are generally connected together (for example by a shaft, not shown, although see below) and rotate together about the axis 20 relative to the stator 12, which is generally fixed (for example in a housing, not shown, although, again, see below). One advantage provided by the arrangement is illustrated in FIG. 1 in that the magnetic circuit 30 is provided by two adjacent stator bars 16 and two magnet pairs 24a,b. Thus, no yolk is required for the stator 12, although a back iron 32a,b is required for each rotor linking the flux between the back of each magnet 24a,b facing away from the respective coils 22. The back iron can be eliminated if the orientation of the magnets is changed (see, for example, WO2010/092403).

Thus, in the case of a motor, by appropriate energization of the coils 22, the rotor 14 can be urged to rotate about the axis 20. Of course, in the situation of a generator, rotation of the rotor 14a,b induces currents in the stator coils 12 according to the changing magnetic flux induced in the stator bars 16 as the rotors 14a,b rotate.

However, in either case heat is generated in the coils 22 and the efficiency of the machine is reduced, and its capacity limited, if this heat is not removed. Accordingly, the present invention suggests enclosing the stator coils 16 within a stator housing and which is supplied with a refrigerant cooling medium.

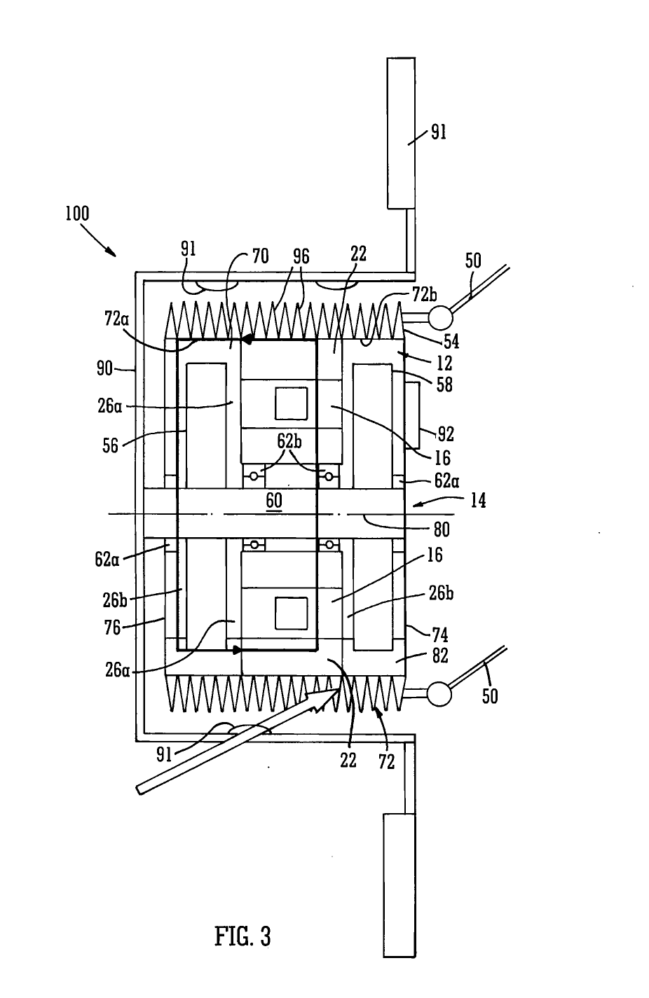

Turning to FIG. 3, a wheel-hub motor 100 according to the present invention comprises a stator 12 mounted on a wishbone 50 of a vehicle (not shown). The stator comprises a housing 54 mounting coils 22 around bars 16. The housing has a cylindrical wall 72, and radial inner and outer end walls 74,76. A rotor 14 comprises two annular plates 56,58 connected at their inner rims to a shaft 60. Shaft 60 is rotationally journalled through bearings 62a in the end walls 74,76. However, it could be mounted directly on the stator coils 22 through bearings 62b. In either case elements 62a seal the walls 74,76 to the shaft 60 whereby an enclosed chamber 70 is defined between the stator 12 and rotor 14. Although the shaft is shown solid, it may be hollow and the bearings 62b may be on a substantial diameter (see, for example, WO2010/092402).

Rotor plates 56,58 are made from any convenient material and are preferably non-ferromagnetic. In that event, annular back irons (not shown) are provided which are of magnetically linking material and on which permanent magnets (also not shown) are disposed. These magnets are aligned with the stator bars 16, and define air gaps 26a,b between them.

A hub 90 of the vehicle is mounted by any convenient means (not shown) on the rotor 14. Also, a brake disc 91 may be mounted on the hub 90 for interaction with a caliper (not shown) mounted on the wishbone 50 (a stationary part thereof with respect to the stator 12).

Power electronics 92 for operating the motor 100 may be mounted on the inner wall 74 of the stator housing, internally or externally of it, as may be preferred. They may be supplied from the vehicle with cabling (not shown). The power electronics 92 control energization of the coils 22 to cause magnetic interaction with the magnets, as described above with reference to FIGS. 1 and 2, and in order to drive the rotor around an axis of rotation 80.

Heat generated by the coils 22 must be dissipated, otherwise the torque capacity of the motor will be limited. For this purpose, the chamber 70 incorporates liquid refrigerant coolant 82 which, when the vehicle is stationary, collects by gravity at the lowest point of the chamber 70. However, when the rotor begins to rotate it, or perhaps paddles (not shown) on it, scoop the liquid coolant 82 and splash the coils 22 around the entire periphery of the stator.

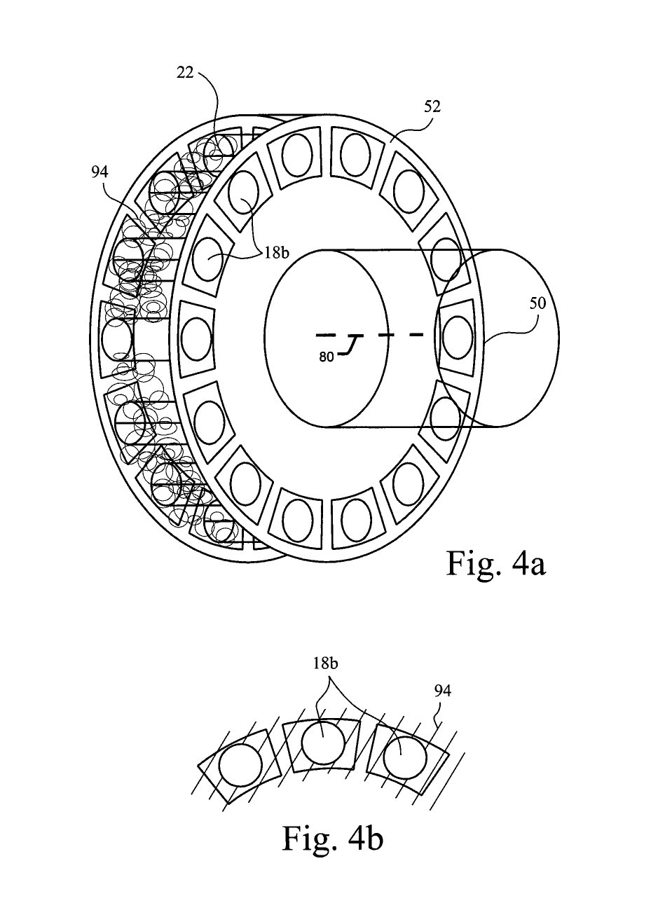

Interspersed between and around the coils 22 is diffuse material 94 (see FIGS. 4a,b) that absorbs the liquid coolant and wets the coils 22. The coils 22 may be mounted in a frame 52 that locates the shoes 18a,b of the bars 16. The diffuse material 94 may be a wicking material, akin to cotton wool, such as rock wool, for example. As heat begins to be generated by the coils 22, this is transferred to the liquid refrigerant. This is arranged to have a boiling point below the desired working temperature of the coils 22. Accordingly, when that temperature is reached, the liquid boils and evaporates so that it is driven away from the coils 22 taking heat with it, further liquid coolant being drawn in by the wicking material 94 by capillary action. The vapor, then filling the chamber 70, contacts inner surfaces 72a,b of the cylindrical wall 72 of stator housing 12 which wall is provided with fins 96. The vapour will also contact the inner surfaces 74a,76a of walls 74,76. The walls 74,76 may also be provided with heat dissipating fins (not shown). At ambient temperature, the coolant is arranged to condense and give up its heat to the material of the stator housing 12 and return to liquid form where the cycle can be repeated.

As the temperature of the motor builds, the vapour pressure in the chamber 70 rises, but it cannot escape if the seal provided by the seals 62a is gas tight. While it does not escape and pressure builds as more heat is generated by the coils 22, the boiling temperature of the liquid increases so that the temperature of the stator housing also increases, shedding heat more quickly. Consequently, although the temperature of the coils also rises, the system is self regulating in shedding heat more quickly as it gets hotter. However, by virtue of the evaporative heat transfer, the temperature gradient between the coils 22 and housing 54 is much less while still transporting heat.

Although the stator housing is stationary (in the vehicle) there are two sources of moving air that flow over the housing 12 between the fins 96, although both are occasioned by vehicle movement. Of course, there is no reason why heat is generated except by vehicle movement, as it is only then that the motor is operated, either in a braking mode or normal operation. There may be times when there is no movement, such as when the vehicle is held by the motor stationary on a hill, as opposed to using a handbrake, whereby heat will be generated, but these situations are rare and, in any event, are usually quickly followed by vehicle motion. Vehicle motion creates its own flow of air and the vehicle can be designed to funnel air towards and over the stator housing fins 96. However, the hub 90 (or the wheel (not shown) mounted on the hub 90) may also or instead be shaped so that its rotation causes a flow of air over the fins 96. Indeed, both the wheel/hub 90 and the fins 96 may be arranged to collaborate in scooping air and drawing it over the stator 12. For example, the hub/wheel 90 may be provided with the scalloped apertures 91. Alternatively, or in addition, the fins 96 may be arranged as a helix screw so that air is directed around the stator 12.

The bearings 62a,b, as the case may be, are shown in contact with the chamber 70. If this is the case, it is important that the coolant 82 act as a lubricant for them. Alternatively, it would be possible at least to isolate the bearings 62a from the chamber 70. For example, the requisite seal could be inboard (with respect to the chamber 70), of the bearing 62a. Further lip seals would be required for bearings 62b (if present) to isolate them from the chamber 70 if desired. It is also important that the coolant 82 does not affect the electronics 92 (if they are mounted internally of wall 74.

Suitable coolants are known to those skilled in the art (such as ethanol, methanol, water, methyl acetate, flouro benzene, 2-heptene) and may be arranged so that the coils have a working temperature in the range ambient-150° C., with a coolant boiling point in the range 50-100° C. between 0.1 bar and 5 bar of pressure, depending on the application. In this scenario, the temperature of the housing 54 will be in the range ambient-80° C.

On the face of it, coils 22 are in direct contact with the stator housing 12 and therefore direct conduction of heat to the housing is possible. This is of course true, but does not result either in a sufficiently fast transport of the heat generated, nor sufficiently wide dissipation of it. In the first instance, the coils 22 are generally wound on the bars 16 and somewhat isolated from the frame 52 which is not designed for heat transport. On the contrary, the mounting of the coils is preferably non-magnetic and may well be of plastics to reduce mass. Plastics is generally a poor conductor of heat. Secondly, even if sufficiently rapid conduction to the housing 12 can be arranged, only a small part of the total surface area of the housing is in contact with the coils so that much capacity to shed heat to the external environment would be unemployed. Furthermore, the heat transfer coefficient between the coils and the housing will be low due to the low the number of interfaces and low thermal conductivity of insulating plastics and potting materials required to make the motor electrically insulated. By employing evaporative cooling, the liquid refrigerant can flow and penetrate every corner of the chamber 70 where heat might be generated, for example, possibly even from the electronics 92, but primarily through and around the coils 22, and secondly, so can the vapour searching for cool spots in the housing on which to condense. Thus a much more event temperature gradient can be provided within the motor 100.

From the foregoing, the mode of operation of the cooling system will be evident. Liquid cooling medium contacts hot parts of the motor by various transport means. Those means are splashing caused by rotation of the rotor, and capillary transport through the diffuse material. When the liquid cooling medium contacts these hot parts, it boils and evaporates absorbing latent heat of vapourisation from the hot parts and as a vapour is driven off through expansion. The vapour penetrates to all corners of the chamber transporting heat therewith. When the vapour contacts cool walls of the chamber it condenses giving up its heat of vaporization and returns as a liquid to the lowest parts of the chamber where the cycle begins again, efficiently distributing heat around the chamber. The external fins of the chamber permit that heat to be shed to the external environment.

An important aspect of the present invention is the avoidance of additional connections with the motor 100. A disadvantage of wheel-hub motors tends to be the necessity for external cooling arrangements bringing cooling medium to and from the motor and that leads to complications in the design. A wheel-hub motor in accordance with the present invention can be self-contained insofar as its cooling arrangements are concerned.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### REFERENCES

T J Woolmer and M D McCulloch “Analysis of the Yokeless and Segmented Armature Machine”, International Electric Machines and Drives Conference (IEMDC), 3-5 May 2007

1. A wheel-hub motor comprising:
a rotor having a rotor field, and
a stator having coils for magnetic interaction with the rotor field across an air gap defined between the rotor and stator;
wherein the stator is a fixed component with respect to a mounting for the motor in a vehicle and the rotor rotates inside the stator that forms a stationary housing defining a sealed chamber between the rotor and stator incorporating cooling medium to cool the coils;
wherein the cooling medium has a boiling point less than a design temperature of operation of the stator coils and more than the design temperature of operation of the stator housing, whereby liquid cooling medium contacting the coils evaporates and gaseous cooling medium contacting the stator housing condenses transferring heat of vaporization between the stator coils and housing;
wherein the stator housing has a heat dissipating external surface for transfer of heat conducted from an internal surface of the stator housing contacted by the gaseous cooling medium; and
wherein the rotor is adapted to mount a hub/wheel such that rotation of the hub/wheel around the stator housing induces a flow of air over the heat dissipating external surface of the housing to accelerate cooling of the housing.

2. The wheel-hub motor of claim 1, wherein the motor is a permanent magnet machine, wherein said rotor field is developed by permanent magnets disposed on the rotor.

3. The wheel-hub motor of claim 1, wherein the motor is an axial flux machine, the coils being wound on bars that are disposed circumferentially spaced around a rotational axis of the rotor.

4. The wheel-hub motor of claim 3, wherein the bars are parallel to the rotational axis.

5. The wheel-hub motor of claim 3, wherein the rotor comprises two stages each having permanent magnets interacting with each end of the bars.

6. The wheel-hub motor of claim 1, wherein the rotor stages each comprise an annular dish, whose inner rims are connected together by a sleeve and which dishes mount said permanent magnets.

7. The wheel-hub motor of claim 1, wherein said stator housing has fins forming a heat-dissipating external surface to shed heat externally.

8. The wheel-hub motor of claim 1, wherein said chamber is sealed on between said stator housing and rotor by a lip seal.

9. The wheel-hub motor of claim 1, wherein diffusive material is disposed around and between said coils whereby liquid cooling medium is captured and transported to the coils by capillary action and gaseous cooling medium generated by the liquid evaporating from the coils is able to escape.

10. The wheel-hub motor of claim 1, wherein a vehicle wheel or hub is mountable on said rotor.

11. The wheel-hub motor as claimed in claim 10, wherein said hub is arranged to have a brake disc mounted thereon.

12. The wheel-hub motor of claim 1, wherein the chamber in use in ambient conditions comprises a volume that is filled to less than about 25% capacity with liquid cooling medium.

13. The wheel-hub motor as claimed in claim 12, wherein the remaining volume is filled only with a vapor cooling medium.

14. The wheel-hub motor of claim 1, wherein electronic components controlling operation of the motor are mounted in said chamber on the stator housing and are cooled by said cooling medium.

15. The wheel-hub motor of claim 1, wherein the rotor is rotationally journalled directly on the stator coils.

16. A vehicle, comprising:
at least one wheel;
a wheel-hub motor mounted within or adjacent the at least one wheel and configured to drive the at least one wheel, the wheel-hub motor including a rotor having a rotor field and a stator having coils for magnetic interaction with the rotor field across an air gap defined between the rotor and stator;
wherein:
the stator is a substantially fixed component with respect to a mounting for the motor in a vehicle and the rotor rotates inside the stator that forms a stationary housing defining a sealed chamber between the rotor and stator incorporating cooling medium to cool the coils;
the cooling medium has a boiling point less than a design temperature of operation of the stator coils and more than the design temperature of operation of the stator housing, whereby liquid cooling medium contacting the coils evaporates and gaseous cooling medium contacting the stator housing condenses transferring heat of vaporization between the stator coils and housing;
the stator housing has a heat dissipating external surface for transfer of heat conducted from an internal surface of the stator housing contacted by the gaseous cooling medium; and
the rotor is adapted to mount a hub/wheel such that rotation of the hub/wheel around the stator housing induces a flow of air over the heat dissipating external surface of the housing to accelerate cooling of the housing.

17. The vehicle of claim 16, wherein the stator is mounted on a wishbone of the vehicle.

18. The vehicle of claim 17, wherein regenerative braking is employed to retard the vehicle, in which event the motor also acts as a generator.

19. The vehicle of claim 17, wherein the wheel or hub has apertures to allow access to air passing the vehicle to flow through the wheel and cool the rotor housing.

20. (canceled)
